(19) United States
(12) Patent Application Publication
(10) Pub. No.: US 2008/0217948 A1
(43) Pub. Date: Sep. 11, 2008

(54) Tailgate lift assembly

(76) Inventor: Alan Kobelman, Debary, FL (US)

Correspondence Address: Alfred F. Hoyte, Jr., Suite 500, 1101 30th Street NW, Washington, DC, 20007, US

(21) Appl. No.: 11/715,370

(22) Filed: Mar. 8, 2007

(51) Int. Cl. B62D 33/03

(52) U.S. Cl. 296/57.1

(57) ABSTRACT

A tailgate lifting assembly. The assembly comprises two components housed in separate enclosures. A first component includes a pair of vertically arranged pulleys and is secured proximate a top edge of the tailgate. A second component is laterally disposed adjacent a side edge of the vehicle, which in the case of a trailer or pickup is a sidewall of the bed. A cable is threaded over the pulleys, which are secured in journaled relation to an interior wall of the housing for the first component. The second component has an interior void through which the cable is threaded, the cable being secured to a spring loaded attachment, the opposing sd secured to the top edge of the tailgate. The two enclosures may be removably mounted to allow for easy transfer to another vehicle.

### BACKGROUND OF THE INVENTION

This invention relates generally to automotive accessories. More specifically, the invention relates to an assisted tailgate lift assembly.

### STATEMENT OF THE PRIOR ART

A common problem with tailgates for station wagons, vans, and especially pickup trucks and trailers, is that the tailgates are extremely heavy. For the elderly, handicapped, or young children, heavy tailgates can be virtually impossible to lift, often resulting in a dangerous situation when the tailgate is disengaged from its closure. Accordingly, numerous solutions to this problem have been proposed.

U.S. Pat. No. 5,954,383 issued to Beck et al. discloses a tailgate lifting system using a stationary pulley and a movable pulley over which a spring loaded cable is threaded. The pulleys are constrained within a track which is bolted to the interior side of the trailer. This system suffers from some drawbacks. First, the movable pulley has an axle mounted within a track which must stay free of debris and be lubricated to avoid the tailgate “hanging up”. Also, both pulleys and the spring are mounted within a single enclosure, which is difficult to access. Finally, the cable is not enclosed and is therefore subject to interference from bulky objects which may be placed in the cargo area of the vehicle.

### SUMMARY OF THE INVENTION

The present invention provides a tailgate lifting assembly. The assembly comprises two components housed in separate enclosures. A first component includes a pair of vertically arranged pulleys and is secured proximate a top edge of the tailgate. A second component is laterally disposed adjacent a side edge of the vehicle, which in the case of a trailer or pickup is a sidewall of the bed. A cable is threaded over the pulleys, which are secured in journaled relation to an interior wall of the housing for the first component. The second component has an interior void through which the cable is threaded, the cable being secured to a spring loaded attachment, the opposing sd secured to the top edge of the tailgate. The two enclosures may be removably mounted to allow for easy transfer to another vehicle.

Accordingly, it is a principal object of the invention to provide a tailgate lift assembly which reduces the effort required to raise and lower an automotive tailgate.

It is another object of the invention to provide an improved tailgate lift assembly having a pair of easily attachable components to facilitate tailgate lifting.

It is another object of the invention to provide an improved tailgate lift 20 assembly which is compact and modular and uses a pair of spring loaded cables to reduce the effective weight of the tailgate to assist with both raising and lowering thereto.

It is another object of the invention to provide an improved tailgate lift 25 assembly which is mounted exteriorly of the vehicle for accessibility.

It is another object of the invention to provide an improved tailgate lift assembly which is inexpensively fabricated from readily available components.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 shows a side view, partly in section, of the tailgate lift assembly of the invention, with the tailgate in the closed position.

FIG. 2 shows a side view, partly in section, of the tailgate lift assembly of the 15 invention, with the tailgate in the open position.

### DETAILED DESCRIPTION

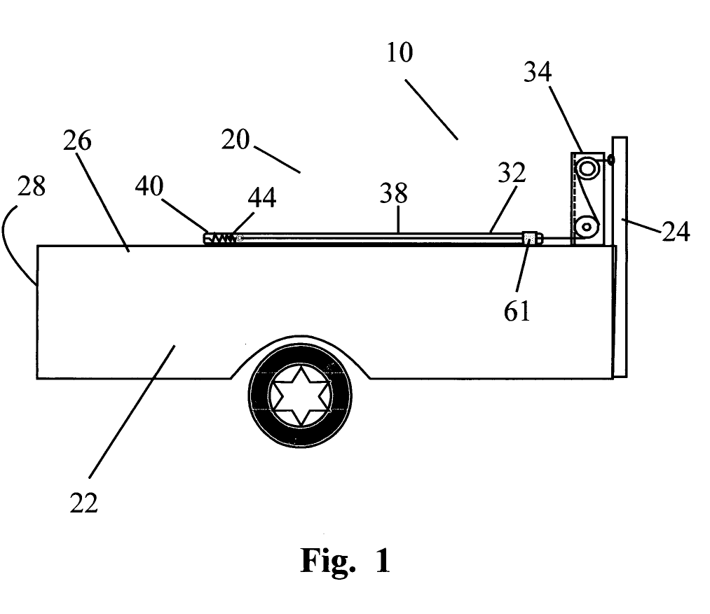

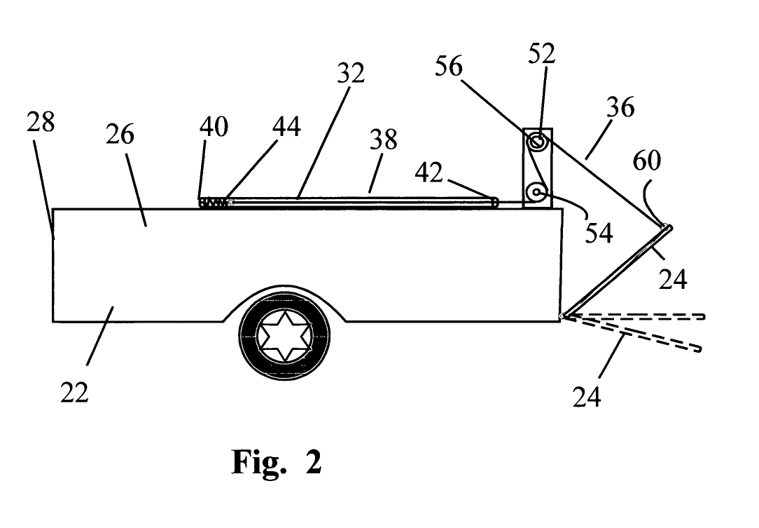

Referring now to FIGS. 1 and 2, the tailgate lift assembly of the present invention, generally indicated by the number 10, is shown. The assembly 10 is primarily intended for use with vehicles having an open cargo bed 20, such as the vehicle 22 shown in FIGS. 1 and 2, but may obviously adapted for other uses. A recurring problem with automotive vehicles having tailgates relates to the weight of the tailgate and the effort required both to open and close it. The gate must be made relatively heavy to ensure the integrity of the vehicle body so that weight reduction is not typically a consideration. Tailgates can be side hinged to open sideways, but this is not a logistically efficient solution, unless the vehicle is to be used in rural areas where tight parking spaces and street parking are not typically encountered. Thus, a tailgate hinged at the bottom to allow for pivoting from a vertical, closed position, to a horizontal or downwardly inclined, open position, is the most effective solution. Accordingly, the arrangement shown in FIGS. 1 and 2 is directed to a bottom hinged tailgate 24.

It can be seen that the vehicle 22 has sidewalls 26 and a forward wall 28 for enclosing the cargo bed 20. The cargo bed 20 may of course be used to contain various items but is typically used to contain large bulky items, hence the open top. This being the case, any aftermarket accessory to be used for facilitating raising or lowering the tailgate 24 should not be hindered by impingement of cargo on the sidewalls 26 or forward wall 28 of the vehicle 22, and should also not be so bulky as to compromise the effective cargo capacity of the bed 20. To that end the lift assembly of the present invention 10 is designed for attachment entirely exteriorly of the cargo bed 20. The assembly 10 has two separately housed, primary components 32, 34 on each side of the vehicle, which are used in combination to effect raising and lowering of the tailgate 24 via corresponding cables 36 which are attached to opposing sides of the tailgate 24.

The first component 32 comprises a tubular, elongated housing 38 within which unobstructed, reciprocal, axial displacement of the cable 36 may occur. The housing 38 may be made from metal or hard plastic such as PVC tubing. The housing 38 has removable apertured end pieces 40, 42 which may be affixed via internal threading to threaded opposing ends of the housing 38. The distal end includes end piece 40 which is fitted with a spring 44 or other motion dampening device such as a hydraulic cylinder. Preferably, a spring is used as it can urge closure of the tailgate 24 in addition to dampening downward movement; The housing 38 is preferably attached to the top of the cargo bed sidewall 26 so as not to compromise cargo bed 20 space. Also, this placement minimizes the extent to which items the cargo bed 20 can impinge upon cable 36. It can be appreciated that housing 38 could be placed within the cargo bed 20, but this would interfere with cargo space and could be accidently dislodged when very heavy items, e.g., appliances such as refrigerators, are placed within the bed 20. Also, the housing 38 may be collapsible, i.e., telescoping, so that it can be collapsed for display and selling purposes, and for increased portability. A key aspect of the invention 10 is that it be readily and easily transferable to another vehicle. To that end, quick disconnect brackets or the like (not shown) may be used to connect the primary components 32, 34 to the cargo bed 20, the bracket securely attached to the vehicle as by welding or other secure means as would be apparent to one of skill in the art.

The second component 34 is a pulley enclosure which includes a rectangular 15 housing 50 with two axles or spindles 52 secured therein. A pair of pulley wheels 54, 56 are connected in journaled relation to the spindles 52. The housing 50 is of course sufficiently large to ensure freedom of rotation of the pulley wheels 54, as well as unencumbered reciprocal movement of the cable 36. Preferably, the housing 50 equipped with an easy opening means such as a hinged panel 58 to allow for 20 inspection and lubrication of the pulley wheels 54 and cable 36. The housing 50 may be made from metal or a hard plastic and, if not connected via the quick disconnect bracket, may be secured atop vehicle sidewalls 26 by welding or other secure attachment means. It can be seen that both components 32, 34 are secured atop the vehicle sidewalls 26 and thus do not occupy any space within the cargo bed 20. Cables 36 are attached directly to the tailgate 24 via eye bolts 60 or other attachment means. The opposite ends of the cable 36 are attached to springs 44. It should be noted that the spring constant and length/number of turns of the springs 44 should be chosen in accordance with the length of travel of cables 36 during opening/closing of the tailgate 24 and the weight of the tailgate 24, as would be readily apparent to one of skill in the art. A 130 lb garage door spring may be used for most applications. Each cable 36 is therefore attached to spring 44 using secure attachment means, threaded through housing 38 and out of the proximal end 42 thereof to the underside of pulley wheel 54, up over the to˜side of pulley wheel 56, and out of component 34 for connection to eye bolts 60. The cable 36 may threaded through a thimble 61 which helps to keep cable axially centered within housing 38.

In use, the system 10 is essentially passive with respect to the user. Opening of the tailgate 24 causes immediate loading of spring 44, lessening the effective weight of the tailgate 24 to the user. When closing the tailgate 24, the spring 44 tends to urge closing, also lessening the effective the weight of the tailgate 24.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

What is claimed is:

1. A tailgate lift assembly for reducing the force required to open and close a vehicle tailgate, said vehicle having a cargo bed with sidewalls, said tailgate hingedly attached to said cargo bed, said assembly comprising:
opposing first components mounted on an upper edge of each of said sidewalls, said components having an elongated tubular housing with opposing, apertured ends;
opposing second components mounted proximate said first components on said sidewall, said second components having a pair of vertically aligned pulley wheels mounted therein in journaled relation; and,
cables mounted in spring loaded relation to distal ends of said first components and fixedly secured to opposing sides of said tailgate.

2. The assembly of claim 1 wherein both of said first and second components are mounted exteriorly of said cargo bed.

3. The assembly of claim 1 wherein said component housing is substantially rectangular, and includes an enclosure for at least one hingedly attached panel.

4. The assembly of claim 1 including means for centering said cable within said tubular housing.
